(19) United States
(12) Patent Application Publication
(10) Pub. No.: US 2023/0373250 A1
(43) Pub. Date: Nov. 23, 2023

(54) MOUNTED ASSEMBLY INCLUDING A PNEUMATIC TIRE

(71) Applicant: COMPAGNIE GENERALE DES ETABLISSEMENTS MICHELIN, Clermont-Ferrand (FR)

(72) Inventors: SYLVIE DUCHEMIN, Clermont-Ferrand (FR); BRUNO GUIMARD, Clermont-Ferrand (FR); PIERRE MOUREAU, Clermont-Ferrand (FR)

(21) Appl. No.: 18/030,674

(22) PCT Filed: Oct. 7, 2021
(86) PCT No.: PCT/FR2021/051743

§ 371 Date: Apr. 6, 2023

(30) Foreign Application Priority Data
Oct. 9, 2020 (FR) FR2010355

(51) Int. Cl. B60C 9/18; B60C 15/02

(52) U.S. Cl. CPC B60C 9/18; B60C 15/02; B60C 2200/04

(57) ABSTRACT

The fitted assembly (10) comprises a tire (11) for a passenger vehicle comprising a working layer (26) which is axially the least wide, the working layer (26) which is axially the least wide having an axial width T2 expressed in mm. The fitted assembly (10) comprises a fitting support (100) comprising a rim (200) with a rim width A according to the manual of the ETRTO 2019 standard, and expressed in mm. The tire (11) has a load rating LI such that LI≥LI′+1, LI′ being the load rating of an EXTRA LOAD tire with the same size according to the manual of the ETRTO 2019 standard. The ratio T2/A is such that T2/A≤1.00.

The present invention concerns a fitted assembly comprising a tire and a passenger vehicle comprising a fitted assembly of this type. “Tire” means a tire which is designed to form a cavity by cooperating with a support element for the fitted assembly, this cavity being able to be pressurized to a pressure greater than atmospheric pressure. A fitted assembly according to the invention has a structure with a form which is substantially toroidal of revolution around a main axis of the fitted assembly which matches the main axis of the tire.

The advent of electric or hybrid motorization passenger vehicles is giving rise to an increase in the weight of the vehicles, in particular because of the batteries, the weight of which is relatively great, and substantially proportional to the autonomy of the vehicles. Thus, for example, in order to increase the autonomy of an electric vehicle, it is necessary to increase the size of the batteries, and consequently the weight of the vehicle.

Expressed simply, it is now estimated that a kilometer of autonomy of an electric motor leads to an increase in the weight of the vehicle by a kilogram. Thus, in order to achieve autonomy of 500 km, it is necessary to increase the weight of a vehicle with thermal motorization by approximately 500 kg. In order to equip such vehicles, it is necessary to use tires which can bear a very heavy load.

A tire for a passenger vehicle is known from the prior art, this tire being able to bear a relatively heavy load. This tire is sold under the MICHELIN™ brand in the Pilot Sport 4 range and has a size of 255/35R18. This tire has an EXTRA-LOAD version (abbreviated to XL) in accordance with the manual of the ETRTO 2019 standard, and, in this EXTRA-LOAD version, it has a load rating equal to 94. This means that, at a pressure of 290 kPa, the tire can bear a load of 670 kg. This load capacity is relatively high compared with a tire which has the same size and is classified as STANDARD LOAD (abbreviated to SL), which has a load rating equal to 90, and can bear a load of 600 kg at a pressure of 250 kPa

In order to be able to be put on the market, a tire of this type must satisfy statutory tests. For example in Europe, the tire must satisfy the load/speed performance test described in annex VII of Regulation no. 30 of the EEC-UNO.

Nevertheless, whether it is in its EXTRA-LOAD version, and even more so in its STANDARD LOAD version, a tire of this type can not bear the additional load corresponding to the batteries necessary in order to achieve the autonomy required. Thus, tire manufacturers have had to propose new solutions in order to respond to this new need.

For a given vehicle, a solution envisaged by the tire manufacturers is the use of tires with a larger size, which would make it possible to bear a heavier load. Thus, a given vehicle could be equipped with tires with a greater load rating. For example, a vehicle equipped with the tires described above in their EXTRA LOAD version could be equipped with tires with a size of 275/35R19 in their EXTRA-LOAD version which have a load rating equal to 100, and which, at a pressure of 290 kPa, can bear a load of 800 kg, far greater than the load of 670 kg.

Firstly, an increase of this type of the size of the tires necessarily gives rise either to a reduction of the interior space of the vehicle, or to enlargement of the outer size of the vehicle, which in both cases is not desirable for reasons of habitability and compactness of the vehicle.

Also, an increase of this type in the size of the tires gives rise to a new design of the chassis of the vehicle, which, for obvious reasons of costs, is not desirable either.

Finally, an increase of this type in the size of the tires, in particular in the width of the nominal cross-section, gives rise to an increase in the exterior noise generated by the tire, as well as to an increase in the rolling resistance, which is not desirable either if it is wished to reduce the noise nuisance and the energy consumption of the vehicle.

Thus, another solution envisaged by tire manufacturers is, for a given size and a given version of a tire, to increase its recommended inflation pressure. In fact, the greater the pressure, the more the tire can bear a heavy load.

However, the use of a relatively high recommended pressure rigidifies the tire and gives rise to a loss of comfort for the passengers of the vehicle, which is obviously not desirable for certain motor vehicle manufacturers in cases where passenger comfort takes precedence over the load which can be borne.

Another problem which is encountered by the manufacturers when developing a tire is the dissipation of energy and the temperature in the structure which can be revealed in particular in the test described in annex VII of Regulation no. 30 of the EEC-UNO. In fact, by increasing the load applied to a tire such as to simulate the addition of a mass corresponding to the batteries necessary in order to obtain the desired autonomy, it has been observed that there is a significant increase in the dissipation of energy and an increase in temperature both in the bead and in the shoulder of the tire.

The objective of the invention is to provide a tire which can bear a heavier load than the existing tires, without necessarily involving an increase in the recommended pressure of the tire, while controlling the dissipation of energy and the increase in the temperature in the structure of the tire without detracting from the habitability, compactness and comfort of the vehicle.

Thus, the subject of the invention is a fitted assembly comprising:
a tire for a passenger vehicle comprising a crown, two beads, two sidewalls which each connect each bead to the crown, and a carcass reinforcement which is anchored in each bead, the crown comprising a crown reinforcement and a tread, the carcass reinforcement extending into each sidewall and into the crown radially into the interior of the crown reinforcement, the crown reinforcement being arranged radially between the tread and the carcass reinforcement, and comprising a working reinforcement comprising at least one working layer which is axially the least wide, the working layer which is axially the least wide having an axial width T2 expressed in mm; and
a fitting support comprising a rim with a rim width A according to the manual of the ETRTO 2019 standard, and expressed in mm;
the tire having a load rating LI such that LI≥LI′+1, LI′ being the load rating of an EXTRA LOAD tire with the same size according to the manual of the ETRTO 2019 standard, and a ratio T2/A is such that T2/A≤1.00.

According to the invention, the tire of the fitted assembly is a tire for a passenger vehicle. A tire of this type is for example defined in the manual of the ETRTO 2019 (European Tyre and Rim Technical Organisation) standard. A tire of this type generally has, on at least one of its sidewalls, marking in conformity with the marking of the manual of the ETRTO 2019 standard indicating the size of the tire in the form X/Y α V∪β, where X designates the width of the nominal cross-section, Y designates the nominal aspect ratio, α designates the structure, and can be R or ZR, V designates the nominal rim diameter, ∪ designates the load rating, and β designates the speed symbol.

The load rating LI′ is the load rating of a tire with the same size, i.e. the same nominal cross-sectional width, the same nominal aspect ratio, the same structure (R and ZR being considered as identical) and the same nominal rim diameter. The load rating LI′ is provided by the manual of the ETRTO 2019 standard, in particular in the part entitled Passenger Car Tyres—Tyres with Metric Designation, pages 20 to 41.

The axial width of the working layer which is axially the least wide is measured on a tire on a meridian cross-sectional plane, and corresponds to the width in the axial direction between the two axial ends of the working layer.

By increasing the load rating of the tire according to the invention in comparison with the load rating of a tire with the same size in its EXTRA-LOAD version, the invention makes it possible to increase the load capacity of the fitted assembly, without however modifying the habitability, the compactness and the comfort of the vehicle on which it is used. In fact, since the size of the tire according to the invention is identical to that of the tire in its EXTRA-LOAD version, the fitted assembly takes up no more space than the tire in its EXTRA-LOAD version. A tire according to the invention will be able to bear distinctive marking, making it possible to distinguish it from its STANDARD LOAD version and its EXTRA-LOAD version, for example marking of the HL (for HIGH LOAD) or XL+ (for EXTRA LOAD+) type. Marking of this type is disclosed in particular in the manual of the ETRTO 2021 standard, page 3 of the section General Notes—Passenger Car Tyres, to designate tires of the HIGH LOAD CAPACITY type. Examples of dimensions are also disclosed in the manual of the ETRTO 2021 standard, page 44, paragraph 9.1 of the section Passenger Car Tyres—Tyres with metric designation.

However, in order to control the dissipations of energy and temperature in the structure during use of the tire according to the invention, it is necessary to have correct dimensions for the axial width of the working layer which is axially the least wide relative to the width of the rim. In fact the inventors at the origin of the invention have discovered that, in the case of a heavy load greater than that known in the prior art, the camber of the tire, i.e. the difference between the radius of the assembly fitted in the absence of a load and the radius of the assembly fitted under this load, was considerably increased. This increase in the camber gives rise to relatively great dissipation of energy and an increase in the temperature in the structure of the tire, in particular in the bead.

In order to control this, the invention proposes to rectify the sidewall of the tire, i.e. to make the sidewall straighter in the radial direction, for the purpose of increasing the radial rigidity of the tire, in order to avoid excessive flexure of the tire and an increase in the dissipation of energy and in the temperature in the structure of the tire. The invention advocates reduction of the ratio T2/A to a value of 1.00 or less in order:
for a given width of rim A, to reduce the axial width T2 of the working layer which is axially the least wide, which gives rise to a reduction in the width of the contact area, and thus to radial rectification of the sidewall of the tire;
for a given axial width T2 of the working layer which is axially the least wide, to increase the width of rim A, which also gives rise to radial rectification of the sidewall of the tire.

In the case when persons skilled in the art vary the axial width T2 of the working layer which is axially the least wide, they will adapt the characteristics of the crown of the tire, in particular those of the crown reinforcement comprising the working reinforcement and optionally a hoop reinforcement, as well as those of the tread according to the axial width T2 which they will have determined.

In both cases, the radial rigidity of the tire is increased, and therefore the camber of the tire is reduced for a given load, which makes it possible to compensate at least partly for the impact of the increase in the load, and there is thus reduction of the stresses exerted on the structure of the tire, and therefore of the dissipation of energy and of the increase in temperature when the tire is in use.

In order to limit the increase in the masses in rotation on the vehicle, but also in order to reduce the size of the fitted assembly so as to assist the habitability and compactness of the vehicle, precedence will be given to the fact of reducing the axial width T2 of the working layer which is axially the least wide, rather than increasing the width of the rim A.

The tire according to the invention has a substantially toric form around an axis of revolution which substantially matches the axis of rotation of the tire. This axis of rotation defines three directions which are conventionally used by persons skilled in the art, i.e. an axial direction, a circumferential direction and a radial direction.

“Axial direction” means the direction which is substantially parallel to the axis of revolution of the tire or of the fitted assembly, i.e. the axis of rotation of the tire or of the fitted assembly.

“Circumferential direction” means the direction which is substantially perpendicular both to the axial direction and to a radius of the tire or of the fitted assembly (in other words, tangent to a circle, the center of which is on the axis of rotation of the tire or of the fitted assembly).

“Radial direction” means the direction according to a radius of the tire or of the fitted assembly, i.e. any direction which intersects the axis of rotation of the tire or of the fitted assembly, and is substantially perpendicular to this axis.

“Median plane of the tire” (indicated as M) means the plane perpendicular to the axis of rotation of the tire which is situated axially halfway between the two beads, and passes via the axial middle of the crown reinforcement.

“Equatorial circumferential plane of the tire” means, on a meridian cross-sectional plane, the plane which passes via the equator of the tire, perpendicular to the median plane and to the radial direction. On a meridian cross-sectional plane (plane perpendicular to the circumferential direction and parallel to the radial and axial directions), the equator of the tire is the axis which is parallel to the axis of rotation of the tire, and is situated equidistantly between the radially outermost point of the tread which is designed to be in contact with the ground, and the radially innermost point of the tire which is designed to be in contact with a support, for example a rim.

“Meridian plane” means a plane which is parallel to, and contains, the axis of rotation of the tire or of the fitted assembly, and is perpendicular to the circumferential direction.

“Radially interior” and respectively “radially exterior” mean respectively closer to the axis of rotation of the tire and further from the axis of rotation of the tire. “Axially interior” and respectively “axially exterior” mean respectively closer to the median plane of the tire and further from the median plane of the tire.

“Bead” means the portion of the tire which is designed to permit the coupling of the tire on a fitting support, for example a wheel comprising a rim. Thus, each bead is in particular designed to be in contact with a flange of the rim permitting coupling thereof.

Any range of values designated by the expression “between a and b” represents the domain of values going from more than a to less than b (i.e. excluding the limits a and b), whereas any range of values designated by the expression “from a to b” signifies the domain of values going from a as far as b (i.e. including the strict limits a and b).

According to an advantageous embodiment, LI′+1≤LI≤LI′+4, preferably LI′+2≤LI≤LI′+4. Thus, the load capacity of the tire is increased further.

According to likewise advantageous embodiments, 0.85≤T2/A, preferably 0.90≤T2/A, and more preferably 0.93≤T2/A≤0.97.

It is preferable to have a ratio T2/A which is not too small. In fact, for a given width of rim A, it is preferable not to reduce excessively the value of the axial width T2 of the working layer which is axially the least wide, at the risk of reducing the flexure rigidity on the edges, and thus the drift rigidity with a strong drift. In addition, if the value of the axial width T2 of the working layer which is axially the least wide is reduced excessively, there is reduction of the width of the area of contact, which increases the pressure exerted on the tread, and thus the wear, this wear being amplified by the fact that the tires according to the invention are designed to bear relatively heavy loads, necessarily resulting in a high level of wear, in all cases higher than for tires of the same size in their EXTRA LOAD version which are required to bear smaller loads. For an axial width T2 of the working layer which is axially the least wide, it is also preferable not to increase excessively the value of the width of rim A, in order, as explained above, to limit the increase in the masses in rotation on the vehicle, but also in order to reduce the size of the fitted assembly, so as to assist the habitability and compactness of the vehicle.

According to preferred embodiments, the tire has a nominal cross-sectional width SW such that T2≥SW−75, preferably T2≥SW−70. For a given nominal cross-sectional width, the working layer which is axially the least wide, which principally defines the width of the area of contact, is not reduced excessively. In fact, as explained above, this makes it possible to maintain good performance in terms of wear of the tire, despite the fact that the tires are designed to bear relatively heavy loads, necessarily resulting in a relatively high level of wear.

According to preferred embodiments, the tire has a nominal cross-sectional width SW such that T2≤SW−27, preferably T2≤SW−30.

In these embodiments, as in the invention in general, the nominal cross-sectional width is that of the marking of the size marked on the sidewall of the tire.

In order to reduce the risk of having the tire fitted on to a rim, the width of which rim would be too small and would give rise to relatively strong flexure of the tire, it will be preferable to limit the rims which can be used with the tire. Thus, the rim is selected from amongst:
a rim with a rim width code equal to the width code of the measurement rim for the size of the tire, and defined according to the manual of the ETRTO 2019 standard; and
a rim with a rim width code equal to the width code of the measurement rim for the size of the tire reduced by 0.5; and
a rim with a rim width code equal to the width code of the measurement rim for the size of the tire increased by 0.5.

The measurement rim is in particular defined on pages 20 to 41 of the part Passenger Car Tyres—Tyres with Metric Designation of the manual of the ETRTO 2019 standard.

Preferably, in order to limit the increase of the masses in rotation on the vehicle, but also in order to reduce the size of the fitted assembly so as to assist the habitability and compactness of the vehicle, the rim has a rim width code equal to the width code of the measurement rim for the size of the tire reduced by 0.5.

According to preferred embodiments, the tire has a nominal cross-sectional width SW ranging from 205 to 315, a nominal aspect ratio ranging from 25 to 55, a nominal rim diameter ranging from 17 to 23, and a load rating LI ranging from 98 to 116, preferably a nominal cross-sectional width SW ranging from 225 to 315, a nominal aspect ratio ranging from 25 to 55, a nominal rim diameter ranging from 18 to 23, and a load rating LI ranging from 98 to 116, and more preferably a nominal cross-sectional width SW ranging from 245 to 315, a nominal aspect ratio ranging from 30 to 45, a nominal rim diameter ranging from 18 to 23, and a load rating LI ranging from 98 to 116. As previously explained, the tires according to the invention are designed to bear relatively heavy loads, necessarily resulting in a relatively high level of wear compared with tires of the same dimensions in their EXTRA LOAD version. Thus, it is particularly advantageous to use tires, the nominal cross-sectional width of which is relatively large, in order to reduce the pressure exerted on the tread, and thus the wear.

Advantageously, 0.82≤H/LI≤0.98. Thus, the invention is preferably applied to tires which can bend relatively substantially since they have a relatively high load rating for a given height of sidewall, i.e. which complies with H/LI≤0.98. This is made possible by the ratio T2/A which permits reduction of the dissipation of energy despite significant bending of the sidewall. However, if the sidewall is too short relative to the load rating, i.e. complying with H/LI<0.82, the bending of the sidewall gives rise to relatively substantial compression of the carcass reinforcement, and thus to an increase in the dissipation of energy.

Particularly preferred embodiments are those in which the tire has a size and a load rating LI selected from amongst the following sizes and load ratings: 225/55R18 105, 225/55ZR18 105 205/55R19 100, 205/55ZR19 100, 235/45R21 104, 235/45ZR21 104, 285/45R22 116, 285/45ZR22 116, 205/40R17 88, 205/40ZR17 88, 245/40R19 101, 245/40ZR19 101, 255/40R20 104, 255/40ZR20 104, 245/40R21 103, 245/40ZR21 103, 255/40R21 105, 255/40ZR21 105, 265/40R21 108, 265/40ZR21 108, 255/40R22 106, 255/40ZR22 106, 255/35R18 98, 255/35ZR18 98, 245/35R20 98, 245/35ZR20 98, 265/35R20 102, 265/35ZR20 102, 245/35R21 99, 245/35ZR21 99, 255/35R21 101, 255/35ZR21 101, 265/35R21 103, 265/35ZR21 103, 275/35R21 105, 275/35ZR21 105, 285/35R21 108, 285/35ZR21 108, 295/35R22 111, 295/35ZR22 111, 275/35R23 108, 275/35ZR23 108, 285/30R21 103, 285/30ZR21 103, 315/30R21 109, 315/30ZR21 109, 325/30R21 111, 325/30ZR21 111, 315/30R23 111, 315/30ZR23 111.

Advantageously, the tire is inflated at a pressure ranging from 200 to 350 kPa, and preferably from 250 to 350 kPa. The pressure is that of the assembly fitted at 25° C., without the tire having travelled. It often corresponds to inflation pressures recommended by the vehicle manufacturers.

In usages in which it will be wished to give precedence to the load capacity of the tire, a relatively high pressure will be used of 270 kPa or more.

In usages in which it will be wished to give precedence to the comfort of the passengers and the performance of the vehicle, in particular the grip on dry ground, a relatively low pressure will be used of 270 kPa or less.

According to some embodiments, the working reinforcement comprises a radially interior working layer and a radially exterior working layer arranged radially on the exterior of the radially interior working layer.

Preferably, the working layer which is axially the least wide is the radially exterior working layer of the working reinforcement.

According to some embodiments, the working layer which is axially the least wide or each working layer is delimited axially by two axial edges of said working layer, and comprises working thread reinforcement elements extending from one axial edge to the other axial edge of said working layer, which elements are substantially parallel to one another.

Optionally, each working thread reinforcement element extends in a main direction which, together with the circumferential direction of the tire, forms an angle, in absolute value, which is strictly greater than 10°, preferably ranging from 15° to 50°, and more preferably ranging from 20° to 35°.

Preferably, in embodiments in which the working reinforcement comprises a radially innermost working layer and a radially outermost working layer arranged radially on the exterior of the radially innermost layer, the main direction in which each working thread reinforcement element of each working thread reinforcement element of the radially innermost working layer extends, and the main direction in which each working thread reinforcement element of the radially outermost working layer extends, form angles with opposite orientations relative to the circumferential direction of the tire.

In embodiments in which the tire has a so-called radial carcass, the carcass reinforcement comprises at least one layer of carcass, the or each layer of carcass being delimited axially by two axial edges of the or each layer of carcass, and the or each layer of carcass comprises carcass thread reinforcement elements extending axially from one axial edge to the other axial edge of the or each layer of carcass.

According to variants, the or each layer of carcass comprises carcass textile thread reinforcement elements extending axially from one axial edge to the other axial edge of the or each layer of carcass in a main direction forming an angle ranging in absolute value from 80° to 90° with the circumferential direction of the tire.

“Thread element” means an element with a length which is at least 10 times longer than the largest dimension of its cross-section, irrespective of the form of this cross-section, i.e. circular, elliptical, oblong, polygonal, and in particular rectangular or square or oval. In the case of a rectangular cross-section, the thread element is in the form of a strip.

“Textile” means a thread element comprising one or a plurality of elementary textile monofilaments optionally coated with one or a plurality of layers of a coating based on an adhesive composition. This or these elementary textile monofilament(s) is/are obtained for example by melt spinning, spinning in solution, or gel spinning. Each elementary textile monofilament is made of an organic material, in particular polymer, or an inorganic material, such as, for example, glass or carbon. The polymer materials can be of the thermoplastic type, such as, for example, aliphatic polyamides, in particular 6-6 polyamides, and polyesters, in particular polyethylene terephthalate. The polymer materials can be of the non-thermoplastic type, such as, for example, aromatic polyamides, in particular aramide, and both natural and artificial cellulose, in particular rayon.

According to a first embodiment, the carcass reinforcement comprises a single layer of carcass.

A carcass reinforcement of this type makes it possible to obtain a tire with an optimal dissipation of energy and operating temperature, in particular with a heavy load, and under pressure lower than, or equal to, the recommended pressure for a tire of the same size in its STANDARD LOAD or EXTRA-LOAD version. In fact, unlike a carcass reinforcement comprising two layers of carcass in which the flexure of each sidewall gives rise to relatively substantial compression of the layer of carcass which is axially furthest to the interior in the sidewall and at the shoulder of the tire, and to an increase in the dissipation of energy. the single layer of carcass has lower compression in the sidewall and at the shoulder, and thus results in a lower and better operating temperature.

In particular, it is advantageous to control this operating temperature in cases of under-inflation which are often and chronically encountered. In fact, it is known that under-inflation leads to an increase in the operating temperature of the sidewalls in the case of tires in their STANDARD LOAD or EXTRA-LOAD version. In the case of a tire of the HIGH LOAD CAPACITY type, under-inflation is even more problematic, and results in an amplified increase in the operating temperature of the sidewalls because of the very heavy load which the tire is bearing.

“Single layer of carcass” means that the carcass reinforcement, with the exception of the layer of carcass, is without any layer reinforced by thread reinforcement elements. The thread reinforcement elements of such reinforced layers excluded from the carcass reinforcement of the tire comprise metal wire reinforcement elements and the textile thread reinforcement elements. Highly preferably, the carcass reinforcement is constituted by the single layer of carcass.

According to this first embodiment, optionally, the tire has a sidewall height H defined by H=SW×AR/100 where SW is the nominal cross-sectional width and AR is the nominal aspect ratio of the tire, and such that H<95.

The tires having a height of sidewall which is relatively reduced have relatively high compression of the carcass reinforcement, all the more so since the load borne is heavy, which is the case of tires having a load rating LI according to the invention. Thus, it is highly advantageous to use a single layer of carcass in combination with a height of sidewall H<95.

In certain embodiments which are optional but nevertheless advantageous, 90≤H<95. In fact, these embodiments have relatively high sidewalls in the range of the heights of sidewalls covered by the first embodiment, and for which the use of a single layer of carcass is particularly advantageous, since it makes it possible to reduce significantly the mass of the tire and the rolling resistance compared with a tire comprising two layers of carcass.

According to a first variant which permits anchorage of the carcass reinforcement by turning back, the single layer of carcass forms a winding around a circumferential reinforcement element of each bead, such that an axially interior portion of the single layer of carcass is arranged axially in the interior of an axially exterior portion of the single layer of carcass, and such that each axial end of the single layer of carcass is arranged radially on the exterior of each circumferential reinforcement element.

According to a second variant which permits anchorage of the carcass reinforcement without turning back, the single layer of carcass has a portion which is arranged axially between two circumferential reinforcement elements of each bead, and each axial end of the single layer of carcass is arranged radially in the interior of each radially exterior end of each circumferential reinforcement element of each bead. A variant of this type of anchorage of the carcass reinforcement is described for example in documents WO2005/113259 or WO2021/123522.

The selection of the anchorage of the carcass reinforcement will be made in particular according to the height of the sidewall H and the rating L1. In fact, the lower the height of the sidewall H and the higher the load rating, the more precedence will be given to the second anchorage variant. In cases where the height of the sidewall H is high and the load rating is low, it will be possible to select the first or the second anchorage variant embodiment equally well.

In the first embodiment, preferably, each carcass textile thread reinforcement element comprises an assembly of at least two multifilament plies, and having a yarn count of 475 tex or more.

In fact, so that the single layer of carcass has sufficient mechanical strength, use will be made of carcass textile thread reinforcement elements with a relatively high yarn count, which, for a given material, makes it possible to obtain relatively high mechanical strength.

Optionally, in the first embodiment, each carcass textile thread reinforcement element has a mean diameter of D≥0.85 mm, and preferably D≥0.90 mm. Also optionally, D≤1.10 mm, and preferably D≤1.00 mm.

In the first embodiment, and for the reasons previously explained, 0.82≤H/LI≤0.92.

According to a second embodiment, the carcass reinforcement comprises first and second layers of carcass.

A carcass reinforcement of this type makes it possible to obtain a reinforcement which is relatively resistant in particular to pinching (“pinch shock”).

According to this second embodiment, optionally, the tire has a height of sidewall H defined by H=SW×AR/100, where SW is the nominal cross-sectional width and AR is the nominal aspect ratio of the tire, and such that H≥95, and preferably H≥100.

The tires having a relatively tall height of sidewall result in relatively significant tension of the carcass reinforcement, in particular of the portion of the carcass reinforcement which is anchored in the bead, for example by means of turning back around a circumferential reinforcement element such as a rod, because of the relatively large volume of inflation gas which they contain in comparison with a tire with a relatively short height of sidewall. This tension is all the greater, the greater the load borne, which is the case for tires with a load rating LI according to the invention. Thus, it is highly advantageous to use two layers of carcass, which makes it possible to reduce the tension applied to each layer of carcass significantly.

In addition, contrary to the tires according to the first embodiment, the tires which have a relatively tall height of sidewall have relatively low compression of the carcass reinforcement. The risk of premature deterioration of the carcass reinforcement, in particular with a heavy load and under a relatively low pressure, is thus avoided despite the presence of two layers of carcass.

Preferably, each first and second layer of carcass extends in each sidewall and in the crown radially in the interior of the crown reinforcement.

According to a preferred variant, one of the first and second layers of carcass forms a winding around a circumferential reinforcement element of each bead, such that an axially interior portion of said layer of carcass is arranged axially in the interior of an axially exterior portion of said layer of carcass, and such that each axial end of said layer of carcass is arranged radially on the exterior of each circumferential reinforcement element.

According to a first preferred configuration which is compatible with the presence of a first and a second layer of carcass:
the first layer of carcass forms a winding around a circumferential reinforcement element of each bead, such that an axially interior portion of the first layer of carcass is arranged axially in the interior of an axially exterior portion of the first layer of carcass, and such that each axial end of the first layer of carcass is arranged radially on the exterior of each circumferential reinforcement element; and
each axial end of the second layer of carcass is arranged radially in the interior of each axial end of the first layer, and is arranged:
   axially between the axially interior and exterior portions of the first layer of carcass; or
   axially in the interior of the axially interior portion of the first layer of carcass;

and preferably, each axial end of the second layer of carcass is arranged axially between the axially interior and exterior portions of the first layer of carcass.

An arrangement of this type of the first and second layers of carcass makes it possible to obtain efficient mechanical coupling between the first and second layers of carcass, thus making it possible to reduce the shearing between the first and second layer of carcass. This therefore reduces the dissipation of energy and the increase in the temperature of the tire, all the more so since the shearing is particularly substantial with heavy loads.

In fact, an arrangement of this type of the carcass reinforcement is particularly advantageous in the case when 95≤H≤155. In fact, by limiting the height of the sidewall of the tire to heights of sidewalls H such that 95≤H≤155, there is a reduction in the volume of gas, and thus in the tension of the carcass reinforcement, to a reasonable level.

In addition, thanks to the particular arrangement of the first and second layers of carcass, unexpectedly, a tire is obtained with dissipation of energy and an operating temperature which are optimal in the sidewall, in particular with a heavy load and under pressure which is lower than, or equal to, the pressure recommended for a tire of the same size in its STANDARD LOAD or EXTRA-LOAD version. This is all the more unexpected since the particular arrangement of the first and second layers of carcass is situated in an area of the tire, in this case in the bead or in the vicinity of the bead, and this makes it possible to reduce the dissipation of energy in another area of the tire, distant from the bead, in this case the sidewall. It has been discovered that the particular arrangement of the carcass reinforcement, i.e. the fact that each axial end of the second layer of carcass is arranged axially between the axially interior and exterior portions of the first layer of carcass, or axially in the interior of the axially interior portion of the first layer of carcass, makes it possible to reduce the difference of tensions between the first layer of carcass and the second layer of carcass. Therefore, the more the difference of tensions between the first and second layers of carcass is reduced, the less shearing is generated between these first and second layers of carcass, and the less energy is dissipated.

According to a second configuration, which is compatible with the presence of a first and a second layer of carcass, the first layer of carcass forms a winding around a circumferential reinforcement element of each bead, such that an axially interior portion of the first layer of carcass is arranged axially in the interior of an axially exterior portion of the first layer of carcass, and such that each axial end of the first layer of carcass is arranged radially on the exterior of each circumferential reinforcement element, and each axial end of the second layer of carcass is arranged radially in the interior of each axial end of the first layer, and is arranged axially on the exterior of each axially exterior portion of the first layer of carcass.

This second configuration is particularly advantageous in the case when H>155. In fact, for tires of the HIGH LOAD CAPACITY type with a very large height of sidewall such that H>155, the tension of the end of the first layer of carcass becomes very high and a carcass reinforcement should be envisaged in which, unlike the arrangement described in the first configuration, each axial end of the second layer of carcass is arranged axially on the exterior of each axially exterior portion of the first layer of carcass. With an arrangement of this type of the carcass reinforcement, the tension of the end of the first layer of carcass will be reduced to a reasonable level.

For tires of the HIGH LOAD CAPACITY type with a very large height of sidewall, i.e. with H>155, even if the difference of tensions between the first layer of carcass and the second layer of carcass remains substantial, the height of the sidewall makes it possible to obtain a relatively large shearing area, which dissipates efficiently the energy, and for which it is not preferable to have the arrangement of the first and second layers of carcass described in the first configuration.

In the second embodiment, preferably, each carcass textile thread reinforcement element comprises an assembly of at least two multifilament plies with a total yarn count of 475 tex or less.

In fact, the presence of two layers of carcass makes it possible to reduce the total yarn count of each carcass textile thread reinforcement element of each layer, while having sufficient mechanical strength of the carcass reinforcement.

Optionally, in the second embodiment, each carcass textile thread reinforcement element of each first and second layer of carcass has respectively a mean diameter D1, D2 such that D1≤0.90 mm et D2≤0.90 mm, preferably D1≤0.85 mm and D2≤0.85 mm, and more preferably D1≤0.75 mm and D2≤0.75 mm.

Relatively small diameters D1 and D2 of this type make it possible to limit the initiation of cracks in the vicinity of the end of each first and second layer of carcass. In fact, the end of each carcass textile thread reinforcement element constitutes a preferential starting point for the initiation of cracks, in particular because it is without any adhesive composition, and therefore adheres poorly to the adjacent matrix in which it is embedded. By reducing each diameter D1, D2, the surface area of the end is reduced, and thus the risk of initiation of cracks. Also optionally, D1 and D2 are such that D1≥0.55 mm and D2≥0.55 mm, and preferably D1≥0.60 mm and D2≥0.60 mm.

in the second embodiment, and for the reasons previously explained, 0.88≤H/LI≤0.98.

Irrespective of whether the first or the second embodiment is involved, the nominal cross-sectional width SW and the nominal aspect ratio AR are of those of the marking of the size written on the sidewall of the tire, and in conformity with the manual of the ETRTO 2019 standard. The yarn counts (or linear densities) of each ply and thread reinforcement element are determined according to the standard ASTM D 885/D 885M-10a of 2014. The yarn count is given in tex (weight in grams of 1000 m of product—as a reminder: 0, 111 tex equals 1 denier).

Both in the first and the second embodiment, the diameter of each carcass textile thread reinforcement element is the diameter of the smallest circle in which the carcass textile thread reinforcement element is circumscribed. The mean diameter is the mean of the diameters of the carcass textile thread reinforcement elements situated along a length of 10 cm of each layer of carcass.

Both in the first and the second embodiment, optionally, each multifilament ply is selected from a multifilament ply made of polyester, a multifilament ply made of aromatic polyamide and a multifilament ply made of aliphatic polyamide, and preferably each multifilament ply is selected from amongst a multifilament ply made of polyester and a multifilament ply made of aromatic polyamide.

“Multifilament ply made of polyester” means a multifilament ply constituted by monofilaments of linear macromolecules formed of groups which are bonded to one another by ester bonds. The polyesters are produced by polycondensation by esterification between a carboxylic diacid or one of its derivatives and a diol. For example, polyethylene terephthalate can be produced by polycondensation of terephthalic acid and ethylene glycol. From amongst the known polyesters, it is possible to cite polyethylene terephthalate (PET), polyethylene naphthalate (PEN), polybutylene terephthalate (PBT), polybutylene naphthalate (PBN), polypropylene terephthalate (PPT), or polypropylene naphthalate (PPN).

“Multifilament ply made of aromatic polyamide” means a multifilament ply constituted by monofilaments of linear macromolecules formed of aromatic groups which are bonded to one another by amide bonds, at least 85% of which are bonded directly to two aromatic cores, and more particularly of fibers made of poly(p-phenylene terephthalate) (or PPTA), which for a long time have been produced from compositions of optically anisotropic spinning. Amongst the aromatic polyamides it is possible to cite the polyarylamides is (or PAA, known in particular by the commercial name Ixef made by the company Solvay), poly(metaxylylene adipamide), polyphthalamides (or PPA, known in particular by the commercial name Amodel made by the company Solvay), amorphous semi-aromatic polyamides (or PA 6-3T, known in particular by the commercial name Trogamid made by the company Evonik), para-aramides (or poly(paraphenylene terephthalamide or PA PPD-T, known in particular by the commercial name Kevlar made by the company Du Pont of Nemours, or Twaron made by the company Teijin).

“Multifilament ply made of aliphatic polyamide” means a multifilament ply constituted by monofilaments of linear macromolecules of polymers or copolymers containing amide functions, which do not have aromatic cycles, and can be synthesized by polycondensation between a carboxylic acid and an amine. Amongst the aliphatic polyamides it is possible to cite the nylons PA4.6, PA6, PA6.6 or also PA6.10, and in particular Zytel made by the company Du Pont, Technyl made by the company Solvay, or Rilsamid made by the company Arkema.

Highly preferably, the assembly is selected from between an assembly of two multifilament plies of polyester and an assembly of a multifilament ply of polyester and a multifilament ply of aromatic polyamide.

Both in the first and the second embodiments, in certain preferred configurations, each axial end of the layer of wound carcass is arranged radially in the interior of the equator of the tire, and more preferably it is arranged at a radial distance of 30 mm or less from a radially interior end of each circumferential reinforcement element of each bead.

By arranging each axial end of the layer of carcass wound in the interior of the equator of the tire, there is significant reduction of the mass of the carcass reinforcement. In addition, the vast majority of rims which are used at present for tires for passenger vehicles have flanges of the “J” type, the height of which is in all cases less than 30 mm. The highly preferential arrangement of each axial end in an area corresponding radially substantially to the rim flange makes it possible to protect each axial end mechanically. In fact, if each axial end were arranged radially too far above each circumferential reinforcement element of each bead, i.e. at a radial distance strictly greater than 30 mm from the radially interior end of each circumferential reinforcement element, each axial end would then be in a flexible area of the tire subjected to excessive stresses, which are particularly great in the case of a tire of the HIGH LOAD CAPACITY type.

Optionally, the crown reinforcement comprises a hoop reinforcement which is delimited axially by two axial edges of the hoop reinforcement, and comprising at least one wrapping thread reinforcement element wound circumferentially helically, such as to extend axially between the axial edges of the hoop reinforcement.

Preferably, the hoop reinforcement is arranged radially on the exterior of the working reinforcement.

Preferably, the or each wrapping thread reinforcement element extends in a main direction which, together with the circumferential direction of the tire, forms an angle, in absolute value, of 10° or less, preferably 7° or less, and more preferably 5° or less.

The subject of the invention is also a passenger vehicle comprising a fitted assembly as defined above.

The invention will be better understood by reading the following description, provided purely by way of non-limiting example, with reference to the drawings in which:

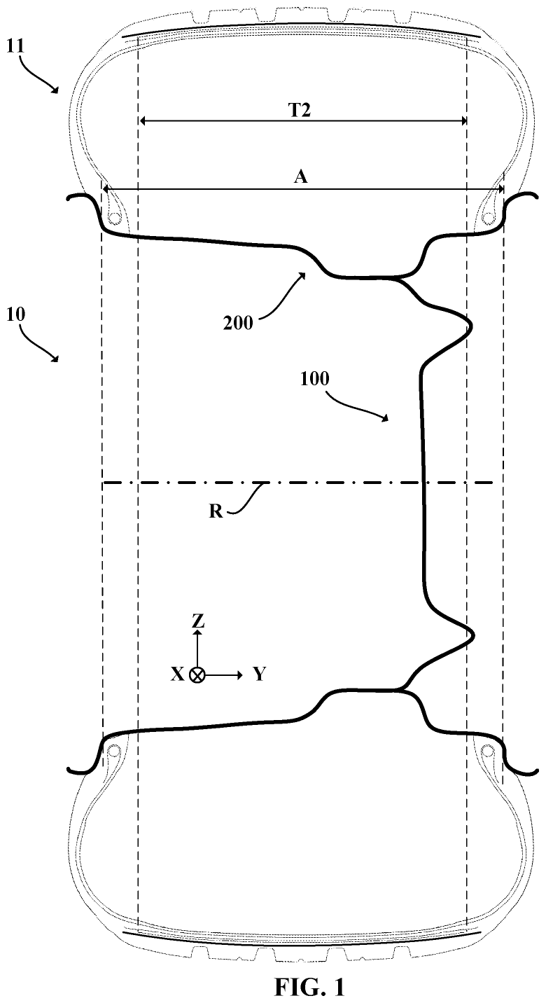

FIG. 1 is a view, on a meridian cross-sectional plane, of an assembly fitted according to a first embodiment of the invention;

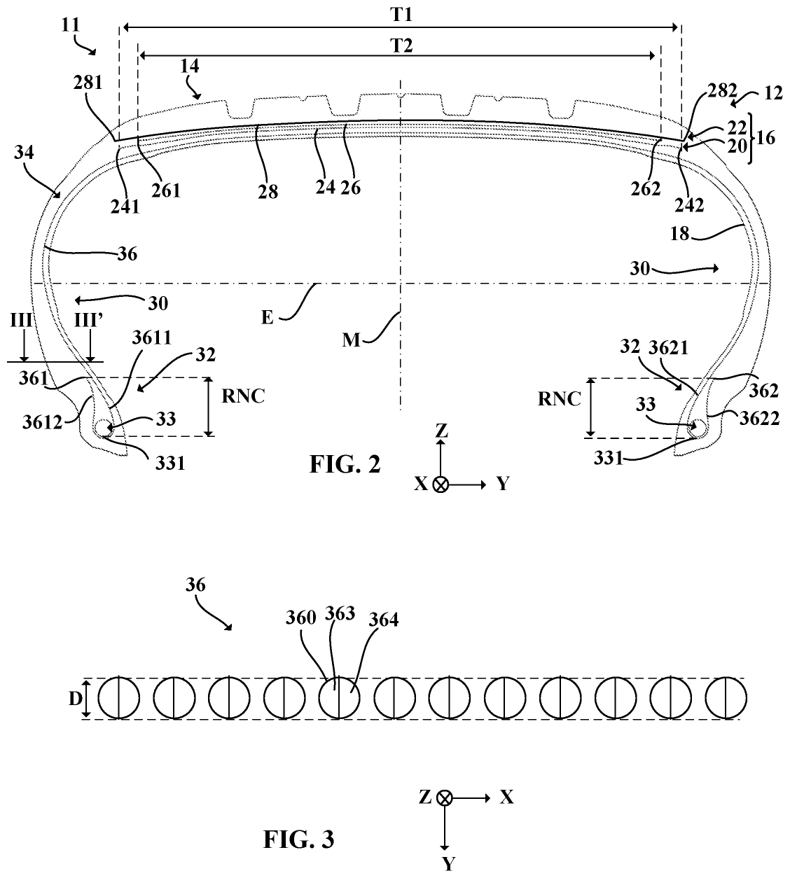

FIG. 2 is a view, on a meridian cross-sectional plane, of the tire of the fitted assembly of FIG. 1;

FIG. 3 is a view in cross-section according to the plane III-III′ of FIG. 2 illustrating the carcass reinforcement of the tire of FIG. 1;

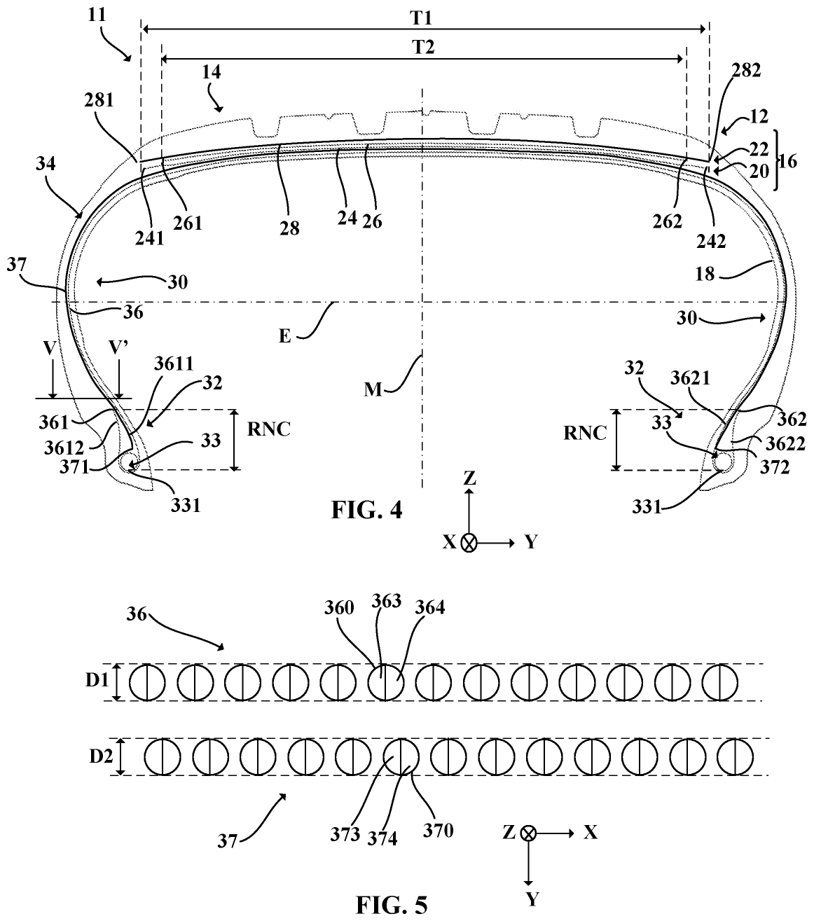

FIGS. 4 and 5 are views similar respectively to FIGS. 2 and 3 of a tire for a fitted assembly according to a second embodiment of the invention; and

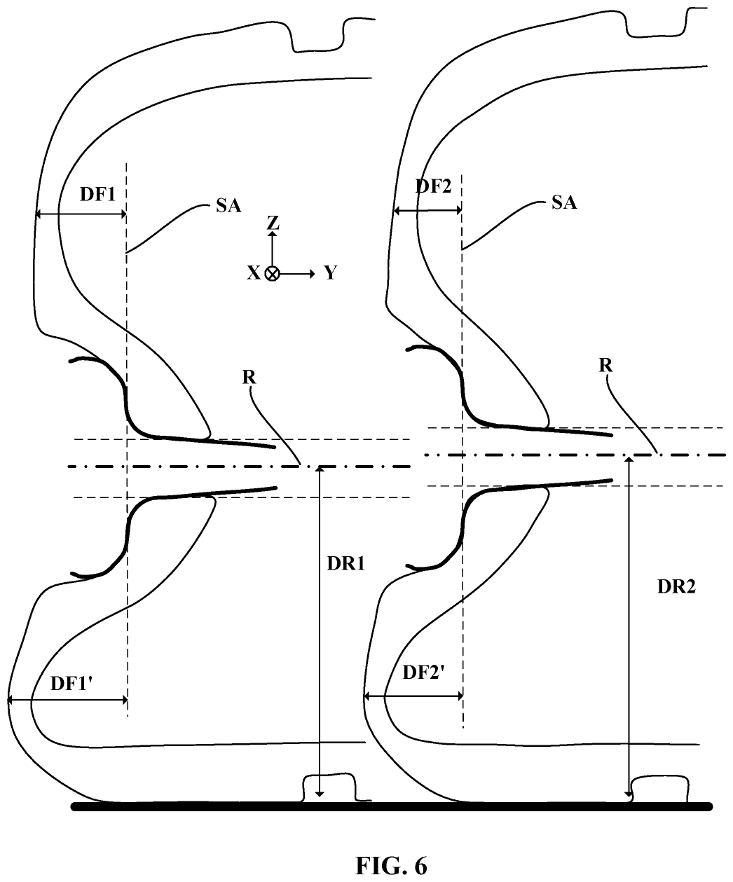

FIG. 6 is a view analogous to that of FIG. 1 comparing the camber of a fitted assembly according to the prior art and that of the fitted assembly of FIG. 1.

In the figures, X, Y, Z represents a reference corresponding to the habitual directions, respectively axial (Y), radial (Z) and circumferential (X), of a tire or of a fitted assembly.

In the following description the measurements made are carried out on a tire which is unloaded and not inflated, or on a cross-section of a tire on a meridian plane.

### Fitted Assembly According to a First Embodiment

FIG. 1 represents a fitted assembly according to the invention designated by the general reference 10. The fitted assembly 10 comprises a tire 11 and a fitting support 100 comprising a rim 200. The tire 11 is in this case inflated to a pressure ranging from 200 to 350 kPa, preferably from 250 to 330 kPa, and in this case equal to 270 kPa.

The tire 11 has a substantially toric form around an axis of revolution R which is substantially parallel to the axial direction Y. The tire is designed for a passenger vehicle. In the different figures, the tire 11 is represented in the new state, i.e. not yet having travelled.

The tire 11 comprises two sidewalls 30 bearing marking indicating the size of the tire 11, as well as a speed rating and speed code. In this case, the tire 11 has a nominal cross-sectional width SW ranging from 205 to 315, preferably 225 to 315, more preferably from 245 to 315, and in this case equal to 255. The tire 11 also has a nominal aspect ratio AR ranging from 25 to 55, preferably ranging from 30 to 45, and in this case equal to 35. The tire 11 has a nominal rim diameter ranging from 17 to 23 and preferably ranging from 18 to 23, and in this case equal to 18. The tire 11 thus has a height of sidewall H defined by SW×AR/100=89<95.

According to the invention, the marking also comprises a load rating LI ranging from 98 to 116, such that LI≥LI′+1, where LI′ is the load rating of an EXTRA LOAD tire with the same size according to the manual of the ETRTO 2019 standard. Preferably, LI′+1≤LI≤LI′+4, and even LI′+2≤LI≤LI′+4.

A tire with a size 255/35R18 in its EXTRA LOAD version has a load rating equal to 94, as indicated on page 36 of the part Passenger Car Tyres—Tyres with Metric Designation of the manual of the ETRTO 2019 standard. Thus, the load rating LI of the tire 11 is such that LI≥95, preferably 95≤LI≤98 and even 96≤LI≤98 and in this case LI=98. This load rating equal to 98 corresponds well to the load rating of a HIGH LOAD CAPACITY tire with a size of 255/35R18, as indicated in the ETRTO 2021 manual. Thus, the tire 11 is of the HIGH LOAD CAPACITY type.

The tire 11 is such that 0.82≤H/LI≤0.98 and preferably 0.82≤H/LI≤0.92 and in this case H/LI=0.91.

For a size of this type, the manual of the ETRTO 2019 standard indicates on page 36 of the part Passenger Car Tyres—Tyres with Metric Designation, a measurement rim with a rim width code equal to 9. The rim 200 of the fitted assembly 10 is thus selected from amongst:
a rim with a rim width code equal to the width code of the measurement rim for the size of the tire, and defined according to the manual of the ETRTO 2019 standard; and
a rim with a rim width code equal to the width code of the measurement rim for the size of the tire reduced by 0.5; and
a rim with a rim width code equal to the width code of the measurement rim for the size of the tire increased by 0.5.

In this case, the rim 200 of the fitted assembly 10 is the rim with a rim width code equal to the width code of the measurement rim for the size of the tire reduced by 0.5, and thus in this case equal to 8.5. The rim 200 has a profile of the type “J” and a rim width A according to the manual of the ETRTO 2019 standard. In this case, since the profile of the rim 200 is of the type 8.5 J, its rim width A expressed in mm is equal to 215.90 mm.

With reference to FIG. 2, the tire 11 comprises a crown 12 comprising a tread 14 which is designed to come into contact with a ground during running, and a crown reinforcement 16 extending in the crown 12 in the circumferential direction X. The tire 11 also comprises a layer 18 of sealing against an inflation gas, which layer is designed to delimit a closed inner cavity together with the fitting support 100 of the tire 11, once the tire 11 has been fitted on the fitting support 100.

The crown reinforcement 16 comprises a working reinforcement 20 and a hoop reinforcement 22. The working reinforcement 16 comprises at least one working layer, and in this case comprises two working layers comprising a radially interior working layer 24 which is arranged radially in the interior of a radially exterior working layer 26. From out of the two, radially interior 24 and radially exterior layers 26, the layer which is axially the least wide is the radially exterior layer 26.

The hoop reinforcement 22 comprises at least one wrapping layer, and in this case comprises one wrapping layer 28.

The crown reinforcement 16 is surmounted radially by the tread 14. In this case the hoop reinforcement 22, in this case the wrapping layer 28, is arranged radially on the exterior of the working reinforcement 20, and is thus radially interposed between the working reinforcement 20 and the tread 14.

The two sidewalls 30 prolong the crown 12 radially towards the interior. The tire 11 also comprises two beads 32 radially in the interior of the sidewalls 30. Each sidewall 30 connects each bead 32 to the crown 12.

The tire 11 comprises a carcass reinforcement 34 which is anchored in each bead 32, and in this case forms a winding around a circumferential reinforcement element 33, in this case a rod. The carcass reinforcement 34 extends radially into each side wall 30, and axially into the crown 12, radially in the interior of the crown reinforcement 16. The crown reinforcement 16 is arranged radially between the tread 14 and the carcass reinforcement 34. The carcass reinforcement 34 comprises at least one carcass layer 36, and in this case a single carcass layer 36.

The hoop reinforcement 22, in this case the wrapping layer 28, is delimited axially by two axial edges 281, 282, and comprises one or a plurality of wrapping thread reinforcement elements wound circumferentially, helically, between each axial edge 281, 282 in a main direction which, together with the circumferential direction X of the tire 10, forms an angle AF, in absolute value, of 10° or less, preferably 7° or less, and more preferably 5° or less. In this case, AF=−5°.

Each radially interior 24 and radially exterior 26 working layer is delimited axially by two axial edges, respectively 241, 242, 261, 262, of each working layer 24, 26. The radially interior working layer 24 has an axial width T1=223.00 mm, and the radially exterior working layer 26 has an axial width T2=209.00 mm, making the radially exterior working layer 26 the working layer which is axially the least wide.

It will be noted that SW=255 and T2=209 satisfy the following equations: T2≥SW−75, preferably T2≥SW−70 and T2≥SW−27, preferably T2≥SW−30.

As illustrated in FIG. 1, the fitted assembly 10 is such that the tire 11 has sidewalls which are rectified radially. In fact, the ratio T2/A is such that 0.85≤T2/A≤1.00, preferably 0.90≤T2/A≤1.00, and more preferably 0.93≤T2/A≤0.97 and in this case T2/A=0.97.

Each working layer 24, 26 comprises working thread reinforcement elements extending axially from one axial edge 241, 261 to the other axial edge 242, 262 of each working layer 24, 26, substantially parallel to one another in main directions which form together with the circumferential direction X of the tire 10 angles respectively AT1 and AT2 with opposite orientations, which, in absolute value, are strictly greater than 10°, preferably ranging from 15° to 50°, and more preferably ranging from 20° to 35°. In this case, AT1=−26° and AT2=+26°.

The single layer of carcass 36 is delimited axially by two axial edges, respectively 361, 362, and comprises carcass textile thread reinforcement elements, respectively 360, extending axially from one axial edge 361 to the other axial edge 362 in a main direction D3 forming with the circumferential direction X of the tire 10 an angle AC, in absolute value, ranging from 80° to 90°, and in this case AC=+90°.

The single layer of carcass 36 forms a winding around each circumferential reinforcement element 33 of each bead 32, such that an axially interior portion 3611, 3621 of the first layer of carcass 36 is arranged axially in the interior of an axially exterior portion 3612, 3622 of the first layer of carcass 36, and such that each axial end 361, 362 of the first layer of carcass 36 is arranged radially on the exterior of each circumferential reinforcement element 33.

Each axial end 361, 362 of the single layer of carcass 36 is arranged radially in the interior of the equator E of the tire. More specifically, each axial end 361, 362 of the first layer of carcass 36 is arranged at a radial distance RNC of 30 mm or less from a radially interior end 331 of each circumferential reinforcement element 33 of each bead 32. In this case, RNC=23 mm.

Each working layer, 24, 26, of wrapping 28 and carcass 36, comprises a die for calendering thread reinforcement elements of the corresponding layer. Preferably, the calendering die is made of polymer, and more preferably elastomer, such as those conventionally used in the domain of tires.

Each wrapping thread reinforcement element conventionally comprises two multifilament plies, each multifilament ply being constituted by a thread of aliphatic polyamide monofilaments, in this case nylon, with a yarn count equal to 140 tex, these two multifilament plies being put into a helix individually at 250 turns per meter in one direction, then put into a helix together at 250 turns per meter in the opposite direction. These two multifilament plies are wound in a helix around one another. As a variant, it will be possible to use a wrapping thread reinforcement element comprising a multifilament ply constituted by a thread of aliphatic polyamide monofilaments, in this case nylon, with a yarn count equal to 140 tex, and a multifilament ply constituted by a thread of aromatic polyamide monofilaments, in this case aramide, with a yarn count equal to 167 tex, these two multifilament plies being put into a helix individually at 290 turns per meter in one direction, then put into a helix together at 290 turns per meter in the opposite direction. These two multifilament plies are wound in a helix around one another. According to yet another variant, it will be possible to use a wrapping thread reinforcement element comprising two multifilament plies each constituted by a thread of aromatic polyamide monofilaments, in this case aramide, with a yarn count equal to 330 tex, and a multifilament ply constituted by a thread of aliphatic polyamide monofilaments, in this case nylon, with a yarn count equal to 188 tex, each of these multifilament plies being put into a helix individually at 270 turns per meter in one direction, then put into a helix together at 270 turns per meter in the opposite direction. These three multifilament plies are wound in a helix around one another.

In general, the use of a heavy load gives rise to a decrease in the acceptable limit speed of the tire, as well as to deterioration of its performance, for example its drift rigidity. Thus, by using one or more wrapping thread reinforcement elements with a high modulus, for example such as those described in the two final variants above comprising one or a plurality of aromatic polyamide plies, it is possible to increase the acceptable limit speed for the tire, and improve the performance, in particular its drift rigidity.

Each working wire reinforcement element is an assembly 4.26 of four steel monofilaments, and comprising an inner layer of two monofilaments and an outer layer of two monofilaments wound together in a helix around the inner layer with a pitch of 14.0 mm, for example in the direction S. An assembly 4.26 of this type has a rupture force equal to 640 N, and a diameter equal to 0.7 mm. Each steel monofilament has a diameter equal to 0.26 mm and a mechanical resistance equal to 3250 MPa. As a variant, it will also be possible to use an assembly of six steel monofilaments with a diameter equal to 0.23 mm, and comprising an inner layer of two monofilaments wound together in a helix with a pitch of 12.5 mm in a first direction, for example in the direction Z, and an outer layer of four monofilaments wound together in a helix around the inner layer with a pitch of 12.5 mm in a second direction, opposite the first direction, for example in the direction S.

As represented in FIG. 3, each carcass textile thread reinforcement element 360 comprises an assembly of at least two multifilament plies 363, 364. Each multifilament ply 363, 364 is selected from amongst a polyester multifilament ply, an aromatic polyamide multifilament ply, and an aliphatic polyamide multifilament ply, preferably selected from between a polyester multifilament ply and an aromatic polyamide multifilament ply. In this case, the assembly is selected from between an assembly off two polyester multifilament plies and an assembly of a polyester multifilament ply and an aromatic polyamide multifilament ply, and in this case is constituted by two PET multifilament plies, these two multifilament plies being put in a helix individually at 270 turns per meter in one direction, then put into a helix together at 270 turns per meter in the opposite direction. Each of these multifilament plies has a yarn count equal to 334 tex, such that the total yarn count of the assembly is 475 tex or more, and in this case equal to 668 tex. Each carcass textile thread reinforcement element 360 has a mean diameter D, expressed in mm, such that D≥0.85 mm, preferably D≥0.90 mm and such that D≤1.10 mm, preferably D≤1.00 mm. In this case, D=0.95 mm.

### Assembly Fitted According to a Second Embodiment

A tire according to a second embodiment will now be described with reference to FIGS. 4 and 5. The elements which are analogous to those of the first embodiment are designated by identical references.

Unlike the first embodiment, the tire 11 is of the size 225/55R18, i.e. with a nominal cross-sectional width SW=225, a nominal aspect ratio AR=55 and a nominal rim diameter in this case equal to 18. The tire 11 according to the second embodiment has a height of sidewall H defined by SW×AR/100=124≥95, and preferably H≥100.

The marking also comprises a load rating LI ranging from 98 to 116, such that LI≥LI′+1, where LI′ is the load rating of an EXTRA LOAD tire with the same size according to the ETRTO 2019 standard. Preferably, LI′+1≤LI≤LI′+4, and even LI′+2≤LI≤LI′+4.

A tire with a size 225/55R18 in its EXTRA LOAD version has a load rating equal to 102, as indicated on page 28 of the part Passenger Car Tyres—Tyres with Metric Designation of the manual of the ETRTO 2019 standard. Thus, the load rating LI of the tire 11 is such that LI≥103, preferably 103≤LI≤106 and even 104≤LI≤106 and in this case LI=105. This load rating equal to 105 corresponds well to the load rating of a HIGH LOAD CAPACITY tire with a size of 225/55R18, as indicated in the ETRTO 2021 manual. Thus, the tire 11 is of the HIGH LOAD CAPACITY type.

For a size of this type, the manual of the ETRTO 2019 standard indicates on page 28 of the part Passenger Car Tyres—Tyres with Metric Designation, a measurement rim with a rim width code equal to 7. Thus, it will be preferable for the rim 200 of the fitted assembly which bears the tire to have a rim width code equal to the measurement rim width code for the size of the tire reduced by 0.5, in this case 6.5, i.e. having a rim width A=165.10 mm.

Each radially inner 24 and radially outer 26 working layer has respectively an axial width of T1=174 mm and T2=160.00 mm.

It will be noted that, just as in the first embodiment, SW=225 and T2=160 mm satisfy the following equations T2≥SW−75, preferably T2≥SW−70 and T2≤SW−27, preferably T2≤SW−30 and the ratio T2/A is such that 0.85≤T2/A≤1.00, preferably 0.90≤T2/A≤1.00 and more preferably 0.93≤T2/A≤0.97 and in this case T2/A=0.97.

Unlike the first embodiment, the tire 11 of the fitted assembly of the second embodiment comprises first and second layers of carcass 36, 37 delimited axially by two axial edges respectively 361, 362, 371, 372 and comprising carcass textile thread reinforcement elements respectively 360, 370 extending axially from one axial edge 361, 371 to the other axial edge 362, 372 in a main direction D3 forming an angle AC with the circumferential direction X of the tire 10, in absolute value, ranging from 80° to 90°, and in this case et AC=+90°.

Each first and second layer of carcass 36, 37 extends into each sidewall 30 and into the crown 12 radially in the interior of the crown reinforcement 16.

The first layer of carcass 36 forms a winding around each circumferential reinforcement element 33 of each bead 32, such that an axially interior portion 3611, 3621 of the first layer of carcass 36 is arranged axially in the interior of an axially exterior portion 3612, 3622 of the first layer of carcass 36, and such that each axial end 361, 362 of the first layer of carcass 36 is arranged radially on the exterior of each circumferential reinforcement element 33. Each axial end 371, 372 of the second layer of carcass 37 is arranged radially in the interior of each axial end of the first layer 361, 362, and is arranged axially between the axially interior and exterior portions 3611, 3612 and 3621, 3622 of the first layer of carcass 36.

Each axial end 361, 362 of the first layer of carcass 36 is arranged radially in the interior of the equator E of the tire. More specifically, each axial end 361, 362 of the first layer of carcass 36 is arranged at a radial distance RNC of 30 mm or less from a radially exterior end 331 of each circumferential reinforcement element 33 of each bead 32. In this case RNC=23 mm.

Each carcass textile thread reinforcement element 360, 370 of each first and second layer of carcass 36, 37 comprises an assembly of at least two multifilament plies 363, 364, 373, 374. In this case, each assembly is constituted by two multifilament plies of PET, these two multifilament plies being put in a helix individually at 420 turns per meter in one direction, then put in a helix together at 420 turns per meter in the opposite direction. Each of these multifilament plies has a yarn count equal to 144 tex, such that the total yarn count of the assembly is 475 tex or less, and in this case equal to 288 tex.

Each carcass textile thread reinforcement element 360, 370 has a mean diameter respectively D1, D2 expressed in mm such that D1≤0.90 mm and D2≤0.90 mm, preferably D1≤0.85 mm and D2≤0.85 mm and more preferably D1≤0.75 mm and D2≤0.75 mm and such that D1≥0.55 mm and D2≥0.55 mm, preferably D1≥0.60 mm and D2≥0.60 mm. In this case, D1=D2=0.62 mm.

Comparative Tests

Static Test

FIG. 6 illustrates the result of a static compression test of the tire with a size 255/35R18 identical to the first embodiment, but wherein the ratio T2/A is equal to 1.05 (tire illustrated on the left), and the tire according to the first embodiment, the ratio T2/A of which is equal to 0.97 (tire illustrated on the right). The load applied to each tire is equal to 750 kg at a pressure of 250 kPa.

It will be noted that the camber of the tire on the left is clearly greater than the camber of the tire on the right. In fact, the distance DR1 of the axis of rotation R on the ground of the tire on the left is shorter than the distance DR2 of the axis of rotation R on the ground of the tire on the right.

It will be noted in particular that the sidewalls of the tire on the right are radially straighter than the sidewalls of the tire on the left. This can be seen by comparing, at the same radial dimension of each sidewall, the distances DF1 and DF2 between the exterior surface of the sidewall situated opposite the area of contact and the plane SA perpendicular to the axis of rotation R of the tire, and passing via the support face of the rim delimiting the axial width A of the rim. This can also be seen by comparing, at the same radial dimension of each sidewall situated in line with the area of contact, the distances DF1′ and DF2′ between the exterior surface of the sidewall and the perpendicular plane SA. It can be observed that DF1>DF2 and that DF1′>DF2′.

Running Test Simulation

In order to demonstrate the advantage of the invention, the inventors simulated the running of a Pilot Sport 4 tire made by MICHELIN with the size 255/35R18 in its EXTRA LOAD version, and having a load rating equal to 94 in conformity with the ETRTO 2019 standard. This tire comprises a crown reinforcement analogous to that of the tires previously described, with the difference that the value of T2 is equal to 226.00 mm.

A plurality of fitted assemblies were simulated comprising the tire described above, fitted on to a plurality of fitting supports comprising rims with three different rim width codes, i.e. 8.5, 9 and 10. For each of these fitted assemblies, a simulation was carried out of a running test analogous to the load/speed performance test described in annex VII of Regulation no. 30 of the EEC-UNO, but in even more stressing conditions and under two different types of conditions.

With the first type of conditions reproducing usage of the tire in its EXTRA-LOAD version, a tire inflated to a pressure equal to 250 kPa under a load equal to 670 kg was simulated. It will be noted that the load applied corresponds to the load which the tire must normally be able to bear, but at a pressure of 290 kPa according to the manual of the, ETRTO 2019 standard. Thus, these first conditions reproduce under-inflated usage of the tire, which is therefore particularly stressing.

With the second type of conditions reproducing usage under a far greater load, a tire inflated to a pressure also equal to 250 kPa under a load equal to 750 kg was simulated. It will be noted that the load applied corresponds to the load which a tire with a load rating 98 at a pressure of 290 kPa must normally be able to bear according to the manual of the ETRTO 2019 standard. Thus, these two conditions reproduce overloaded and under-inflated usage of the tire, which are therefore even more stressing than the first conditions.

During these simulations, the maximum of the volumetric energy dissipation DNRJ of the calendering die was measured for a portion of the carcass reinforcement, in this case the single layer of carcass, situated in the sidewall, expressed in daN/mm². The greater this value, the greater the dissipation of energy by the structure of the tire is, and the greater the temperature increase is. These values were related to a relative value 100, below which the energy dissipation is controlled, and above which the energy dissipation is not sufficiently controlled. These values are included in table 1 below. NT means that the fitted assembly was not tested.

TABLE 1

| | | Result of the test at | Result of the test at |
|---|---|---|---|
| A | | P = 250 kPa and under | P = 250 kPa and under |
| (Inches) | T2/A | a load of Z = 670 kg | a load of Z = 750 kg |
| 8.5 | 1.05 | DNRJ >120 | NT |
| 9 | 0.98 | DNRJ <100 | DNRJ <100 |
| 10 | 0.89 | NT | DNRJ <50 |

These tests show that the decrease in the ratio T2/A makes it possible to control the dissipation of energy in the portion of the carcass reinforcement, in this case of the single layer of carcass, situated in the sidewall, even under a relatively heavy load, and with a pressure lower than the pressure recommended to bear the corresponding load. Thus, according to the invention, it will be possible to make T2 and/or A vary in order to obtain a ratio T2/A which makes it possible to straighten the sidewalls, and thus reduce the stresses exerted on the carcass reinforcement.

The invention is not limited to the embodiments previously described.

1.-15. (canceled)

16. A fitted assembly (10) comprising:
a tire (11) for a passenger vehicle comprising a crown (12), two beads (32), two sidewalls (30) which each connect each bead (32) to the crown (12), and a carcass reinforcement (34) which is anchored in each bead (32), the crown (12) comprising a crown reinforcement (16) and a tread (14), the carcass reinforcement (34) extending into each sidewall (30) and into the crown (12) radially into an interior of the crown reinforcement (16), the crown reinforcement (16) being arranged radially between the tread (14) and the carcass reinforcement (34), and comprising a working reinforcement (20) comprising at least one working layer (26) which is axially least wide, the working layer (26) which is axially least wide having an axial width T2 expressed in mm; and
a fitting support (100) comprising a rim (200) with a rim width A according to standard ETRTO 2019 and expressed in mm,
wherein the tire (11) has a load rating LI such that LI≥LI′+1, where LI′ is a load rating of an EXTRA LOAD tire with a same size according to standard ETRTO 2019, and
wherein a ratio T2/A is such that T2/A≤1.00.

17. The fitted assembly (10) according to claim 16, wherein LI′+1≤LI≤LI′+4.

18. The fitted assembly (10) according to claim 16, wherein 0.85≤T2/A.

19. The fitted assembly (10) according to claim 18, wherein 0.90≤T2/A.

20. The fitted assembly (10) according to claim 16, wherein the tire (11) has a nominal cross-sectional width SW such that T2≥SW−75 and T2≤SW−27.

21. The fitted assembly (10) according to claim 16, wherein the rim (200) is selected from:
a rim with a rim width code equal to a width code of a measurement rim for a size of the tire, and defined according to standard ETRTO 2019;
a rim with a rim width code equal to a width code of a measurement rim for a size of the tire reduced by 0.5; and
a rim with a rim width code equal to a width code of a measurement rim for a size of the tire increased by 0.5.

22. The fitted assembly (10) according to claim 16, wherein the tire (11) has a nominal cross-sectional width SW ranging from 205 to 315, a nominal aspect ratio ranging from 25 to 55, a nominal rim diameter ranging from 17 to 23, and the load rating LI ranging from 98 to 116.

23. The fitted assembly (10) according to claim 16, wherein 0.82≤H/LI≤0.98, H being a sidewall height defined by H=SW×AR/100, where SW is a nominal section width and AR is a nominal aspect ratio of the tire.

24. The fitted assembly (10) according to claim 16, wherein the tire (11) has a size and load rating LI selected from the following sizes and load ratings: 225/55R18 105, 225/55ZR18 105, 205/55R19 100, 205/55ZR19 100, 235/45R21 104, 235/45ZR21 104, 285/45R22 116, 285/45ZR22 116, 205/40R17 88, 205/40ZR17 88, 245/40R19 101, 245/40ZR19 101, 255/40R20 104, 255/40ZR20 104, 245/40R21 103, 245/40ZR21 103, 255/40R21 105, 255/40ZR21 105, 265/40R21 108, 265/40ZR21 108, 255/40R22 106, 255/40ZR22 106, 255/35R18 98, 255/35ZR18 98, 245/35R20 98, 245/35ZR20 98, 265/35R20 102, 265/35ZR20 102, 245/35R21 99, 245/35ZR21 99, 255/35R21 101, 255/35ZR21 101, 265/35R21 103, 265/35ZR21 103, 275/35R21 105, 275/35ZR21 105, 285/35R21 108, 285/35ZR21 108, 295/35R22 111, 295/35ZR22 111, 275/35R23 108, 275/35ZR23 108, 285/30R21 103, 285/30ZR21 103, 315/30R21 109, 315/30ZR21 109, 325/30R21 111, 325/30ZR21 111, 315/30R23 111, and 315/30ZR23 111.

25. The fitted assembly (10) according to claim 16, wherein the tire (11) is inflated to a pressure ranging from 200 to 350 kPa.

26. The fitted assembly (10) according to claim 16, wherein the working reinforcement (20) comprises a radially interior working layer (24) and a radially exterior working layer (26) arranged radially on an exterior of the radially interior working layer (24).

27. The fitted assembly (10) according to claim 16, wherein the working layer which is axially least wide (26) or each working layer (24, 26) is delimited axially by two axial edges (241, 242, 261, 262) of the working layer (24, 26) and comprises working thread reinforcement elements extending axially from one axial edge to an other axial edge of the working layer (24, 26) substantially parallel to one another.

28. The fitted assembly (10) according to claim 27, wherein each working thread reinforcement element extends in a main direction which, together with a circumferential direction (X) of the tire (11), forms an angle, in absolute value, which is strictly greater than 10°.

29. The fitted assembly (10) according to claim 16, wherein the carcass reinforcement (34) comprises at least one layer of carcass (36, 37), the or each layer of carcass (36, 37) being delimited axially by two axial edges (361, 362, 371, 372) of the or each layer of carcass (36, 37), and comprises carcass textile thread reinforcement elements (360, 370) extending axially from one axial edge to an other axial edge of the or each layer of carcass (36, 37) in a main direction forming an angle ranging, in absolute value, from 80° to 90° with a circumferential direction (X) of the tire (11).

30. The fitted assembly (10) according to claim 16, wherein the carcass reinforcement comprises a single carcass layer, the tire having a sidewall height H defined by H=SW×AR/100 with SW being a nominal section width and AR a nominal aspect ratio of the tire and such that H<95 and that 0.82≤H/LI≤0.92.

31. The fitted assembly (10) according to claim 30, wherein the single carcass layer forms a winding around a circumferential reinforcing element of each bead such that an axially inner portion of the single carcass layer is arranged axially on an inside of an axially outer portion of the single carcass layer and such that each axial end of the single carcass layer is arranged radially on an outside of each circumferential reinforcing element.

32. The fitted assembly (10) according to claim 30, wherein the single carcass layer has a portion arranged axially between two circumferential reinforcing elements of each bead and each axial end of the single carcass layer is arranged radially on an inside of each radially outer end of each circumferential reinforcing element of each bead.

33. The fitted assembly (10) according to claim 16, wherein the carcass reinforcement comprises first and second carcass layers, the tire having a sidewall height H defined by H=SW×AR/100 with SW being a nominal section width and AR a nominal aspect ratio of the tire and such that H≥95 and that 0.88≤H/LI≤0.98.

34. The fitted assembly (10) according to claim 16, wherein the crown reinforcement (16) comprises a hoop reinforcement (22) which is delimited axially by two axial edges (281, 282) of the hoop reinforcement, and comprising at least one wrapping thread reinforcement element wound circumferentially, helically, such as to extend axially between the axial edges (281, 282) of the hoop reinforcement (22).

35. A passenger vehicle comprising at least one fitted assembly (10) according to claim 16.
